(19) United States
(12) Patent Application Publication
(10) Pub. No.: US 2019/0039064 A1
(43) Pub. Date: Feb. 7, 2019

(54) BIO CHIP STRUCTURE FOR COMPARATIVE EXPERIMENT

(71) Applicants: MBD KOREA. CO., LTD., Yongin-si, Gyeonggi-do (KR); MEDICINAL BIOCONVERGENCE RESEARCH CENTER, Suwon-si, Gyeonggi-do (KR)

(72) Inventors: Dong Woo LEE, Yongin-si (KR); Chan Ho PARK, Suwon-si (KR); Sung Hoon KIM, Suwon-si (KR)

(73) Assignees: MBD KOREA. CO., LTD., Yongin-si, Gyeonggi-do (KR); MEDICINAL BIOCONVERGENCE RESEARCH CENTER, Suwon-si, Gyeonggi-do (KR)

(21) Appl. No.: 16/075,500

(22) PCT Filed: Aug. 9, 2017
(86) PCT No.: PCT/KR2017/008608

§ 371 Date: Aug. 3, 2018

(30) Foreign Application Priority Data
Aug. 12, 2016 (KR) 10-2016-0103247

(51) Int. Cl. B01L 3/00

(52) U.S. Cl. CPC B01L 3/50857; B01L 2300/0819

(57) ABSTRACT

Provided is a bio chip structure for a comparative experiment. The bio chip structure for a comparative experiment according to the present invention may include: a first pillar substrate including at least one first pillar where a first sample is disposed; a second pillar substrate including at least one second pillar where a second sample is disposed; and a well substrate including wells to which at least one pair of the first pillars of the first pillar substrate and the second pillar of the second pillar substrate is inserted. Accordingly, a comparative experiment to culture a different kind of samples may be conducted in an identical environment, a different kind of samples, which are the subjects of a comparative experiment, may be rapidly and accurately disposed on a plurality of pillars, and an experimental group or a control group may be easily replaced.

### BACKGROUND OF THE INVENTION

### 1. Field of the Invention

The present invention relates to a bio chip structure for a comparative experiment, and more particularly, to a bio chip structure for a comparative experiment by which a comparative experiment to culture a different kind of samples may be conducted in an identical environment, a different kind of samples, which are the subjects of a comparative experiment, may be rapidly and accurately disposed on a plurality of pillars, and an experimental group or a control group may be easily replaced.

### 2. Description of the Related Art

In general, a bio chip is a micro chip in which samples of biological micro-substances such as DNA, protein, and cells are disposed on a small substrate and are analyzed in terms of genetic defect, protein distribution, and responses. The bio chip includes a pillar substrate including a plurality of pillars, where samples are disposed, and a well substrate including a plurality of wells where pillars are inserted.

However, as disclosed in Korean Patent Application Publication No. 10-2013-0084394 and Korean Patent Registration Publication No. 10-1218986, pillars are inserted into wells one-to-one and thus, a comparative experiment to culture a different kind of samples in an identical environment may not be conducted. Also, since a plurality of pillars is formed on one substrate in the conventional art, samples to be compared may not be accurately identified and disposed in each pillar.

In addition, since samples are disposed in simple cylindrical-structure pillars and the pillars are inserted into cylindrical groove-structure wells, inner side walls of the wells may collide with the pillars by an external force or vibration and thereby, the samples disposed in the pillars may be separated or damaged.

### SUMMARY OF THE INVENTION

The present invention provides a bio chip structure for a comparative experiment by which a comparative experiment to culture a different kind of samples may be conducted in an identical environment, a different kind of samples, which are the subjects of a comparative experiment, may be rapidly and accurately disposed on a plurality of pillars, and an experimental group or a control group may be easily replaced.

According to an aspect of the present invention, there is provided a bio chip structure for a comparative experiment including: a first pillar substrate comprising at least one first pillar where a first sample is disposed; a second pillar substrate comprising at least one second pillar where a second sample is disposed; and a well substrate comprising wells to which at least one pair of the first pillars of the first pillar substrate and the second pillar of the second pillar substrate is inserted.

The first pillar substrate and the second pillar substrate may be combined with each other.

The first pillar substrate and the second pillar substrate may be combined with each other by using a magnet member.

The first pillar substrate may include a plurality of first protruding members having at least one first pillar and a first support member for supporting the plurality of first protruding members so that the plurality of first protruding members may be spaced apart from each other and placed in order, and the second pillar substrate may include a plurality of second protruding members having the second pillars to respectively correspond to the plurality of first protruding members and a second support member for supporting the plurality of second protruding members so that the plurality of second protruding members may be spaced apart from each other and placed in order.

The plurality of first protruding members and the plurality of second protruding members may be combined with each other by sliding coupling.

At least one of the plurality of first protruding members may have a guide groove or a guide projection to guide sliding coupling and the second protruding member, which corresponds to the first protruding member, may have a guide projection or a guide groove to correspond to the guide groove or the guide projection of the first protruding member.

The first pillar or the second pillar may be tapered from the corresponding pillar substrate toward the end part thereof where samples are respectively disposed.

The first pillar substrate may further include a first stepped unit between the first pillar substrate and the first pillar, the second pillar substrate may further include a second stepped unit between the second pillar substrate and the second pillar, and the first stepped unit and the second stepped unit may be adjacent to each other, when the first pillar substrate and the second pillar substrate combine with each other, to have a shape corresponding to the inner surface of the well.

At least one of the first stepped unit and the second stepped unit may include an air outlet groove to discharge the inner air of the well, when the at least one of the first stepped unit and the second stepped unit is inserted into the well.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of a bio chip structure for a comparative experiment according to an embodiment of the present invention;

FIG. 2 is a perspective view illustrating that a first pillar substrate and a second pillar substrate of FIG. 1 are separated from each other;

FIG. 3 is a vertical cross-sectional view illustrating that pillars are inserted into wells of the bio chip structure of FIG. 1 for a comparative experiment according to an embodiment of the present invention;

FIG. 4 is a vertical cross-sectional view illustrating that pillars are inserted into the wells of a bio chip structure of FIG. 1 for a comparative experiment according to another embodiment of the present invention;

FIG. 5 is a vertical cross-sectional view illustrating that pillars are inserted into the wells of a bio chip structure of FIG. 1 for a comparative experiment according to another embodiment of the present invention; and

FIG. 6 is a perspective view illustrating that a first pillar substrate of FIG. 5 combines with a second pillar substrate of FIG. 5.

### DETAILED DESCRIPTION OF THE INVENTION

The present invention will now be described more fully with reference to the accompanying drawings, in which exemplary embodiments of the invention are shown. In the description, the detailed descriptions of well-known technologies and structures may be omitted so as not to hinder the understanding of the present invention. In addition, terms in the present invention are defined in consideration of functions according to the present invention and may be changed according to an intention of a user or an operator or a usage. Therefore, definitions of the terms should be construed based on the description of the specification.

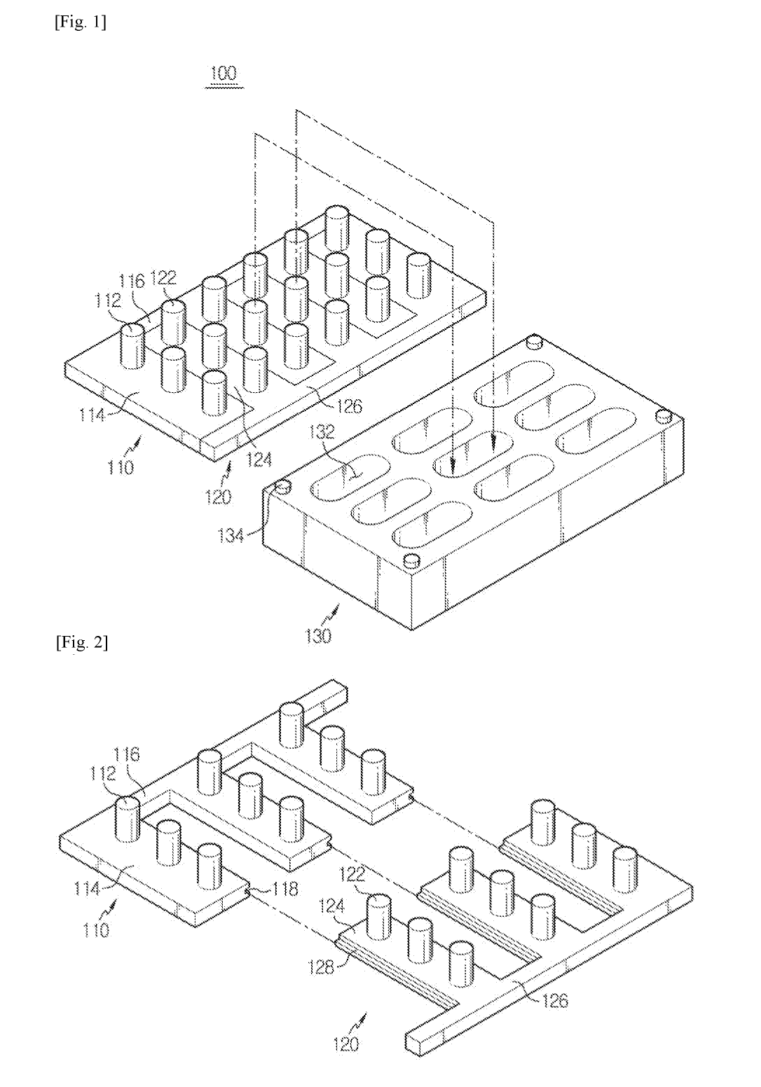

FIG. 1 is a perspective view of a bio chip structure 100 for a comparative experiment according to an embodiment of the present invention.

As illustrated in FIG. 1, the bio chip structure 100 for a comparative experiment may include a first pillar substrate 110, a second pillar substrate 120, and a well substrate 130.

The first pillar substrate 110 may include at least one first pillar 112 in which a first sample is disposed. The second pillar substrate 120 may include at least one second pillar 122 in which a second sample is disposed. In this case, the first pillar substrate 110 and the second pillar substrate 120 may be combined with each other. Also, when the second pillar substrate 120 combines with the first pillar substrate 110, the second pillar substrate 120 may include the second pillars 122 to correspond to the first pillars 112.

In general, the first and second pillar substrates 110 and 120 may include a plurality of first and second micro pillars 112 and 122 on one side of the flat-type substrate. At the ends of the first and second pillars 112 and 122, samples including biological micro-substances such as DNA, protein, and cells may each be disposed. In order to facilitate disposition of the samples, a predetermined dispersed material layer (not illustrated) may be each coated on the ends of the first and second pillars 112 and 122. Such a dispersed material layer includes porous materials through which a solution such as a culture fluid or a reagent may penetrate. For example, the dispersed material layer may include sol-gel, hydrogel, alginate gel, Organogel, Xerogel, or collagen. In this case, the sample is dispersed on the dispersed material layer.

The first pillar substrate 110 and the second pillar substrate 120 may be combined with each other and separated from each other. For example, the first pillar substrate 110 and the second pillar substrate 120 may be combined with each other by using a magnet member (not illustrated). For example, the magnet member may be placed on a contact surface where the first pillar substrate 110 and the second pillar substrate 120 are combined with each other.

In addition, the first pillar substrate 110 and the second pillar substrate 120 may be combined with each other and separated from each other.

FIG. 2 is a perspective view illustrating that the first pillar substrate 110 and the second pillar substrate 120 are separated from each other.

As illustrated in FIG. 2, the first pillar substrate 110 and the second pillar substrate 120 may have a gear tooth so that the first pillar substrate 110 and the second pillar substrate 120 may be combined with each other and separated from each other

For example, the first pillar substrate 110 may include a plurality of first protruding members 114 and a first support member 116. In this case, each of the plurality of first protruding members 114 may include at least one first pillar 112. The first support member 116 may support the plurality of first protruding members 114 so that the plurality of first protruding members 114 may be spaced apart from each other and placed in order.

The second pillar substrate 120 may include a plurality of second protruding members 124 and a second support member 126. In this case, the plurality of second protruding members 124 may include the second pillars 122 to respectively correspond to the plurality of first protruding members 114 of the first pillar substrate 110. That is, the number of the second protruding members 124 of the second pillar substrate 120 corresponds to the number of the first protruding members 114 of the first pillar substrate 110. Also, when the first pillar substrate 110 and the second pillar substrate 120 are combined with each other, the second protruding members 124 may include the second pillars 122 at positions corresponding to the first pillars 112 of the first protruding members 114. The second support member 126 may support the plurality of second protruding members 124 so that the plurality of second protruding members 124 may be spaced apart from each other and placed in order.

In this case, the plurality of first protruding members 114 and the plurality of second protruding members 124 may be combined with each other by sliding coupling. Thus, at least one of the plurality of first protruding members 114 has a guide groove 118 to guide sliding coupling and the second protruding member 124, which corresponds to the first protruding member 114, may have a guide projection 128 to correspond to the guide groove 118 of the first protruding member 114. According to an embodiment, the first protruding member 114 may have a guide projection to guide sliding coupling and the second protruding member 124, which corresponds to the first protruding member 114, may have a guide groove to correspond to the guide projection.

As described above, when the first and second pillar substrates 110 and 120 are formed to be combined with each other and separated from each other, the first pillar substrate 110 and the second pillar substrate 120 may be separated from each other so that sample A may be only placed on the first pillar substrate 110 and sample B may be only placed on the second pillar substrate 120. Accordingly, the samples to be compared may be rapidly and accurately identified and disposed. In addition, the first pillar substrate 110 and the second pillar substrate 120 may be separated from each other to combine another substrate and thus, an experimental group or a control group may be easily replaced.

Referring back to FIG. 1, the well substrate 130 may include wells 132 to which at least one pair of first pillar 112 of the first pillar substrate 110 and second pillar 122 of the second pillar substrate 120 is inserted. For example, each well 132 formed on one side of the well substrate 130 may be formed so that pairs of first and second pillars 112 and 122, which are made by combining the first pillar substrate 110 with the second pillar substrate 12, may be respectively inserted into one well 132, or two or more pairs may be inserted into one well 132. That is, each well 132 may be formed so that not only one pair of first and second pillars 112 and 122 may be inserted into one well 132 according to a position and a size of the pair but also a plurality of pairs of the first and second pillars 112 and 122 may be inserted into one well 132. In addition, the shape of the wells 132 may be a circular groove or an oval groove or may vary according to the form of the first and second pillars 112 and 122.

The well substrate 130 may include spacer members 134. The spacer members 134 are located between a combination of the first and second pillar substrates 110 and 120 and the well substrate 130 and prevent the wells 132 from being sealed when the combination of the first and second pillar substrates 110 and 120 combines with the well substrate 130.

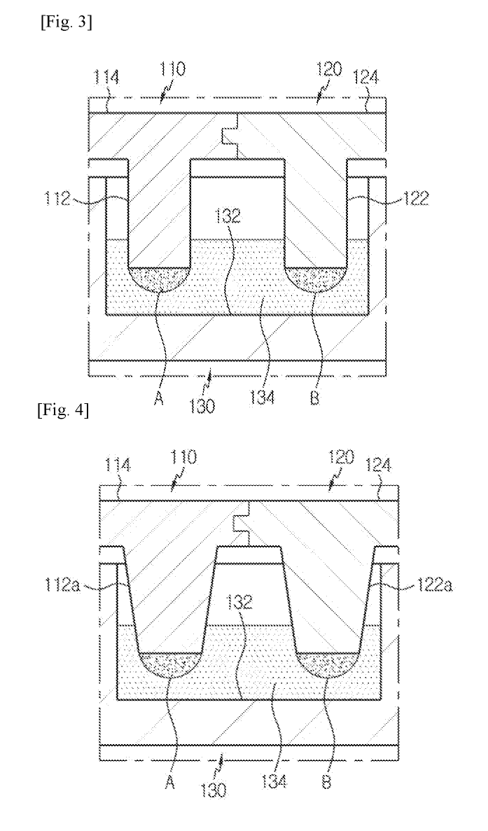

FIG. 3 is a vertical cross-sectional view illustrating that the first and second pillars 112 and 122 are inserted into the wells 132 of the bio chip structure of FIG. 1 for a comparative experiment according to an embodiment of the present invention.

As illustrated in FIG. 3, a certain amount of a solution such as a culture fluid or a reagent is respectively poured and accommodated within the wells 132 formed on the well substrate 130. The combination of the first and second pillar substrates 110 and 120 may combine with the well substrate 130 so that samples A and B disposed in the pair of the first and second pillars 112 and 122 may be placed within the solution in the well 132. In this case, sample A may be disposed in the first pillar 112 of the first pillar substrate 110 and sample B to conduct a comparative experiment with sample A may be disposed in the second pillar 122 of the second pillar substrate 120. After a predetermined time passes, an experimenter may observe and analyze a state of samples A and B disposed in the first and second pillars 112 and 122 by using a fluorescence microscope while the first and second pillars 112 and 122 are combined with the well 132 or the first and second pillars 112 and 122 are separated from the well 132. Accordingly, the first and second pillar substrates 110 and 120 may be formed of a resin composition which has excellent light transmittance. For example, the first and second pillar substrates 110 and 120 may be formed of a resin composition including Polystyrene and Maleic Anhydride.

As described above, a comparative experiment for a different kind of samples may be efficiently conducted in an identical environment made in the identical well 132.

FIG. 4 is a vertical cross-sectional view illustrating that first and second pillars 112a and 122a are inserted into the wells 132 of a bio chip structure of FIG. 1 for a comparative experiment according to another embodiment of the present invention.

As illustrated in FIG. 4, the first pillar 112a of the first pillar substrate 110 or the second pillar 122a of the second pillar substrate 120 may be tapered from the corresponding pillar substrate toward the end part thereof where samples A and B are respectively disposed. Accordingly, even if an external force or a vibration occurs, other end parts of the first and second pillars 112a and 122a, which are relatively large at the side of the first pillar substrate 110 and second pillar substrate 120, may only contact the side wall of the well 132. Therefore, a collision between the first and second pillars 112a and 122a and the side wall of the well 132 may relieve and samples A and B, which are respectively disposed at the end parts of the first and second pillars 112a and 122a, may be prevented from directly colliding with each other.

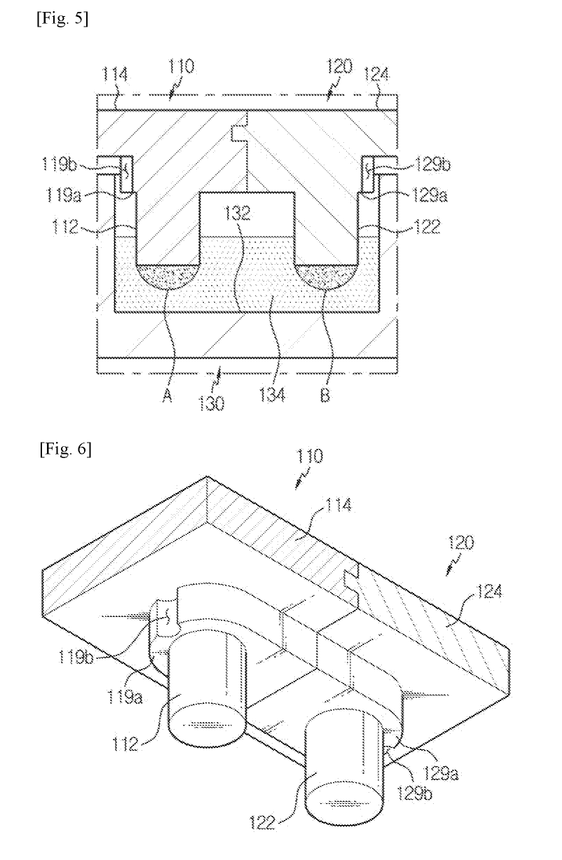

FIG. 5 is a vertical cross-sectional view illustrating that the first and second pillars 112 and 122 are inserted into the wells 132 of a bio chip structure of FIG. 1 for a comparative experiment according to another embodiment of the present invention. FIG. 6 is a perspective view illustrating that the first pillar substrate 110 of FIG. 5 combines with the second pillar substrate 120 of FIG. 5.

As illustrated in FIGS. 5 and 6, the first pillar substrate 110 may further include a first stepped unit 119a between the first pillar substrate 110 and the first pillar 112 and the second pillar substrate 120 may further include a second stepped unit 129a between the second pillar substrate 120 and the second pillar 122. Such the first stepped unit 119a and the second stepped unit 129a respectively have a larger diameter than the first pillar 112 and the second pillar 122 and are inserted into the well 132. Then, when an external force or a vibration occurs, a collision between the first and second pillars 112 and 122 and the side wall of the well 132 may relieve and samples A and B disposed in the first and second pillars 112 and 122 may be prevented from being separated or damaged.

In this case, the first stepped unit 119a and the second stepped unit 129a are adjacent to each other, when the first pillar substrate 110 and the second pillar substrate 120 combine with each other, and thus, a coupling of the first stepped unit 119a and the second stepped unit 129a may form a shape corresponding to the inner surface of the well 132. For example, when the inner surface of the well 132 is a circular groove, the first stepped unit 119a and the second stepped unit 129a are respectively a semicircle. Accordingly, when the first pillar substrate 110 and the second pillar substrate 120 combine with each other, the first stepped unit 119a and the second stepped unit 129a are adjacent to each other and thus, a circular shape may be formed.

In addition, at least one of the first stepped unit 119a and the second stepped unit 129a may have an air outlet groove 119b or 129b, in order to discharge the air from the well 132. Since the coupling of the first stepped unit 119a and the second stepped unit 129a is similar to the shape of the well 132, a collision therebetween may relieve. However, the inner air of the well 132 may be hardly discharged and thus, the combination of the first pillar substrate 110 and the second pillar substrate 120 may be hardly combined with the well substrate 130. Accordingly, the air outlet grooves 119b and 129b may rapidly discharge the inner air of the well 132 along with the spacer members 134 described above, when the first stepped unit 119a and the second stepped unit 129a are inserted into the well 132.

According to the present invention, a pair of the pillars, where samples are respectively disposed, is inserted into an identical well in a bio chip, wherein the bio chip includes a plurality of independent experiment environment with space efficiency. Thus, a comparative experiment to culture a different kind of samples may be conducted in an identical environment and reliability and efficiency of the comparative experiment may also be improved. In particular, the first and second pillar substrates are formed to be combined with each other and separated from each other, and a pair of the respective pillars of the first pillar substrate and the second pillar substrate is inserted into an identical well, when the first and second pillar substrates are combined with each other. Thus, a different kind of samples, which are the subjects of a comparative experiment, may be rapidly and accurately disposed on a plurality of pillars, and an experimental group or a control group may be easily replaced. Also, the pillars are tapered toward the end parts thereof, where samples are respectively disposed, or a stepped unit having a shape corresponding to the inner surface of the well is included between the pillar substrate and the pillar so that a collision occurring due to an external force or a vibration between the pillars and the side wall of the well may relieve and the samples disposed in the pillars may be prevented from being separated or damaged. In addition, since an air outlet groove is formed on the stepped unit, the air outlet groove may rapidly discharge the inner air of the well, when the stepped unit is inserted into the well. Furthermore, it may be obvious that various technical problems, which are not described in the description of the present invention, may be solved through the embodiments of the present invention above not only in the technical field of the present invention but also in related technical fields.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A bio chip structure for a comparative experiment comprising:
a first pillar substrate comprising at least one first pillar where a first sample is disposed;
a second pillar substrate comprising at least one second pillar where a second sample is disposed; and
a well substrate comprising wells to which at least one pair of the first pillars of the first pillar substrate and the second pillar of the second pillar substrate is inserted.

2. The bio chip structure of claim 1, wherein the first pillar substrate and the second pillar substrate are combined with each other.

3. The bio chip structure of claim 2, wherein the first pillar substrate and the second pillar substrate are combined with each other by using a magnet member.

4. The bio chip structure of claim 2, wherein the first pillar substrate comprises a plurality of first protruding members having at least one first pillar and a first support member for supporting the plurality of first protruding members so that the plurality of first protruding members is spaced apart from each other and placed in order, and the second pillar substrate comprises a plurality of second protruding members having the second pillars to respectively correspond to the plurality of first protruding members and a second support member for supporting the plurality of second protruding members so that the plurality of second protruding members is spaced apart from each other and placed in order.

5. The bio chip structure of claim 4, wherein the plurality of first protruding members and the plurality of second protruding members are combined with each other by sliding coupling.

6. The bio chip structure of claim 5, wherein at least one of the plurality of first protruding members has a guide groove or a guide projection to guide sliding coupling and the second protruding member, which corresponds to the first protruding member, has a guide projection or a guide groove to correspond to the guide groove or the guide projection of the first protruding member.

7. The bio chip structure of claim 1, wherein the first pillar or the second pillar is tapered from the corresponding pillar substrate toward the end part thereof where samples are respectively disposed.

8. The bio chip structure of claim 1, wherein the first pillar substrate further comprises a first stepped unit between the first pillar substrate and the first pillar, the second pillar substrate further comprises a second stepped unit between the second pillar substrate and the second pillar, and the first stepped unit and the second stepped unit are adjacent to each other, when the first pillar substrate and the second pillar substrate combine with each other, to form a shape corresponding to the inner surface of the well.

9. The bio chip structure of claim 8, wherein at least one of the first stepped unit and the second stepped unit comprises an air outlet groove to discharge the inner air of the well, when the at least one of the first stepped unit and the second stepped unit is inserted into the well.
